(19) United States
(12) Patent Application Publication
(10) Pub. No.: US 2009/0287563 A1
(43) Pub. Date: Nov. 19, 2009

(54) Method for funding a plurality of charities or similar organizations through flexible allocation of credit card rebates and similar contributions

(75) Inventors: John M. Mone, Randolph, NJ (US); Dan A. Rosenberg, Warren, NJ (US)

Correspondence Address: DAY PITNEY LLP, 7 TIMES SQUARE, NEW YORK, NY, 10036-7311, US

(73) Assignee: BONFORI LLC

(21) Appl. No.: 12/152,185

(22) Filed: May 13, 2008

(51) Int. Cl. G06Q 20/00

(52) U.S. Cl. 705/14.33; 705/39

(57) ABSTRACT

The disclosure relates to a method and apparatus wherein consumers, typically credit card holders, can allocate their rebates and similar financial incentives amongst a plurality of charitable or non-profit institutions or other destinations. The method and apparatus further allows additional sources of funding such as rebates from additional credit cards, participating merchant rebate programs, incentives from banks or other financial institutions, donated airline miles and similar incentives, and payroll deductions. Likewise, the method and apparatus further allows additional destinations for a portion of the funding, including investment vehicles which are personally owned, and points or miles in airline or similar programs.

### BACKGROUND OF THE INVENTION

1. Field of the Invention

The present invention pertains to a method of allocation of credit card rebates and similar contributions, to fund a plurality of charities, non-profit groups and financial instruments.

2. Description of the Prior Art

It is well-known in the prior art for a financial institution to give incentives to the consumer to use the credit card issued by the financial institution. It is also well-known in the prior art for merchants to give incentives to encourage consumers to purchase their goods and/or services. These incentives have typically been in the form of points for airline travel, gift certificates for specific merchants, or cash rebates. The cash rebates may be in the form of a check given directly to the consumer, or the rebate may be given as contributions to financial instruments, such as a “529” college saving plan. One percent of the value of the charged purchases is a typical amount used to fund the banking rewards for credit card use, although other values may be used. Similarly, it is known in the prior art to use affinity programs wherein this rebate amount is granted to a large national charitable or non-profit group. University alumni programs are a typical example, wherein the credit card states that the cardholder is a member of the alumni association of a particular university, and a percentage of purchases is contributed to the alumni association of the university. Similarly, a large national charity may solicit donors to receive and use credit cards wherein a percentage of purchases is contributed to the large national charity. Smaller charities or similar organizations are typically challenged to generate the volume of interest to justify the affinity card.

Prior art which is related to the above description includes U.S. Pat. No. 7,313,543 to Crane entitled “System and Method for Dividing a Remittance and Distributing a Portion of the Funds to Multiple Investment Vehicles”; U.S. Pat. No. 6,631,358 to Ogilvie entitled “Promoting Savings by Facilitating Incremental Commitments made with Credit Card and Other Consumer-Initiated Transactions”; U.S. Pat. No. 6,345,261 to Feidelson entitled “Customer Loyalty Investment Program”, U.S. Pat. Nos. 5,202,826, 5,117,355, 4,941,090 and Re. 36,116, all to McCarthy and entitled “Centralized Consumer Cash Value Accumulation System for Multiple Merchants”.

However, this prior art has been deficient in allowing a consumer to fund a plurality of charities or similar organizations from a plurality of financial sources.

### OBJECTS AND SUMMARY OF THE INVENTION

It is therefore an object of the present invention to allow a cardholder to use sources of funds contributed to the platform to fund a plurality of charities or non-profit groups of various sizes.

It is therefore a further object of the present invention to allow a cardholder to use sources of funds contributed to the platform to fund other financial instruments.

This and other objects are attained by providing a method and apparatus wherein a cardholder can allocate the revenue from the cash rebate and similar financial incentives from credit card use (or other financial sources or enhancements) amongst a plurality of charities or non-profit organizations. The selection of non-profit organizations may be limited to those which are tax-exempt. The user typically chooses from amongst a list of tax-exempt organizations as defined by Internal Revenue Service regulations 501(c) (this applies to the United States, other countries would typically use an analogous standard) and assigns a percentage to each of the various organizations, the percentages preferably totaling 100 percent. The rebates and similar financial incentives associated with the credit card use are then allocated in accordance with these percentages, aggregated with similar rebates, if any, allocated by other cardholders and distributed to the various organizations.

### DESCRIPTION OF THE DRAWINGS

Further objects and advantages of the invention will become apparent from the following description and claims, and from the accompanying drawings, wherein:

FIG. 1 is a schematic of the method and apparatus of an embodiment of the present invention.

FIG. 2 is an expanded schematic, from a database point of view, of the method and apparatus of an embodiment of the present invention.

FIG. 3 is a simplified example spreadsheet showing the possible allocation by five members amongst five charitable or tax-exempt organizations or similar destinations.

FIG. 4 is a schematic of a further embodiment of the present invention.

### DETAILED DESCRIPTION OF THE PREFERRED EMBODIMENT

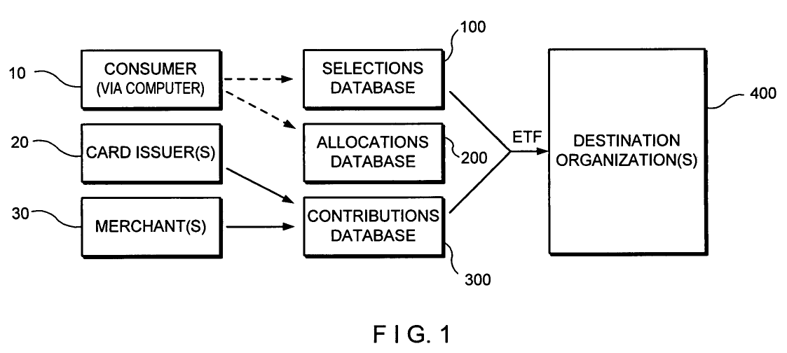

Referring now to the drawings in detail wherein like numerals indicate like elements throughout the several views, one sees that FIG. 1 is a schematic of the method and apparatus of an embodiment of the present invention. Database 100 is provided to store the selections for charitable or other tax-exempt organizations. Database 100 would typically include such information as the name and address of the organization, along with other contact information and possibly information concerning the electronic funds transfer routing information and further information to confirm the 501 (c) charitable or tax-exempt status of the organization. Additionally, consumers (members), typically via a computer 10 (including all of the typical components of a computer—processor, memory, storage, screen, input ports, output ports, etc.) with internet access (although paper-based and similar methods can be substituted whereby an employee of the system owner would enter the data into the database via a computer) to the secure website can choose their charities, tax-exempt organizations or similar organizations (typically pre-loaded, but some embodiments may allow the user to enter contact information regarding the organization) and enter the desired percentage allocation data (alternatively, fractions could be used) into database 200, typically totaling one hundred percent. A simple example would be to allocate twenty-five percent of the available rebates to each of four different charities or other eligible organizations. The allocation information may also include “not to exceed” amounts or fixed amounts subject to funding. Consumers (members) would be free to make changes to the selection of charities, tax-exempt organization, or similar organizations at any time in accordance with changing affinities of the consumer. The consumer would likewise apply for a credit card from card issuer 20 which would establish the amount of donations available to be allocated (such as, but not limited to, one percent of purchases and perhaps some percentage of the interest accrued, sometimes referred to as a “rebate”). The rebate would typically be transferred by electronic funds transfer and would accrue in account or database 300. This rebate would typically be based, at least in part, on data originally derived from point-of-sale or similar credit card transactions, as recorded on the credit card accounts of the various participating consumers (members). Additionally, participating merchants 30 could enter into the program whereby some percentage of the purchases made by the consumer from the participating merchant, either with the credit card from credit card issuer 20 or from any financial source (even including cash purchases) with proper documentation of the affinity relationship (such as a merchant-issued loyalty or affinity card, or even the credit card itself used for identification purposes). Participating merchants 30 would then likewise direct a portion of the purchase price to account or database 300, typically via electronic funds transfer. However, some merchants may choose to rely on paper-based checks or any other similar method to transfer the funds. However, it is envisioned that most, if not all, calculations and transactions would be performed by computers or similar devices.

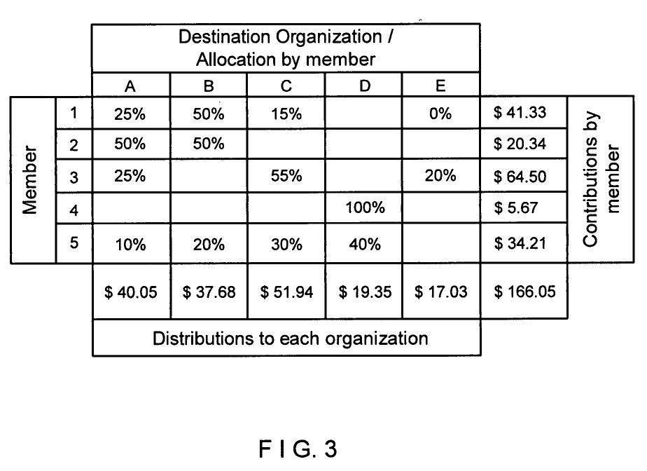

Periodically, a computer or other electronic calculating device would access databases 100, 200 and 300 to multiply the contributions from each consumer by the stated allocations and determine the contribution for each charity or similar tax-exempt organization 400. If more than one consumer generated a contribution to the same charity or similar tax-exempt organization 400, these contributions would be aggregated (see, for example, FIG. 3). The resulting funds transfer from database or account 300 to the charities of tax-exempt organizations would typically be done by electronic funds transfer or a similar method.

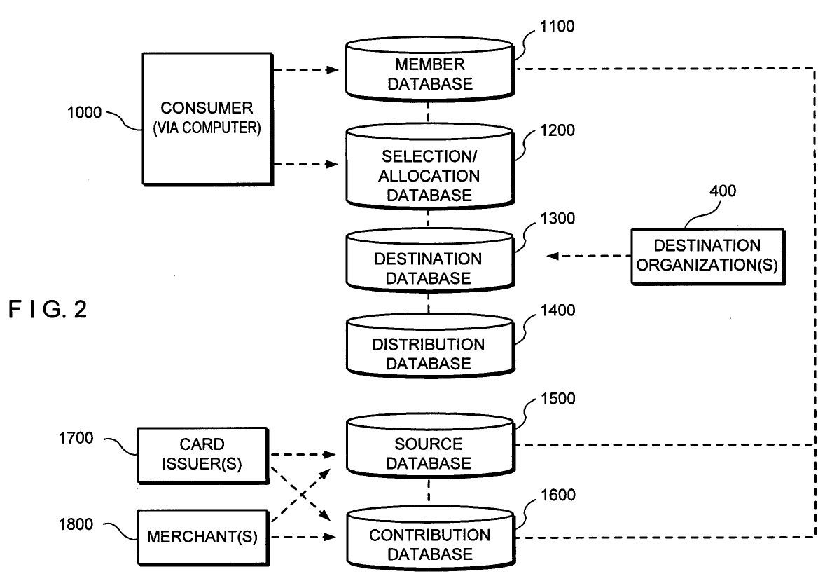

A similar embodiment is illustrated in FIG. 2. The consumer, typically through a computer at block 1000 enters credit card account information, or application data to receive a credit card, into member database 1100 and similarly enters allocation data into selection/allocation database 1200. Member database 1100 is further linked to the source database 1500 (which identifies any entity that is configured on the system to make affinity contributions, such as various card issuers and individual merchants) and the contribution database 1600 (which tracks active contributions made by the various entities identified in the source database 1500) which allows a single website sign-on to resolve multiple accounts, such as multiple participating credit cards and participating merchant loyalty or affinity cards. The link to source database 1500 allows contribution information from various participating sources to be linked back to an individual member.

Destination database 1300 includes data regarding the various destination organizations 400 and further includes the various possible endpoints for affinity distributions. The individual member selection entries are derived from entries in this database.

Distribution database 1400 includes data for tracking the distribution made to potential destination endpoints for historical tracking and display.

Source database 1500 and contribution database 1600, described above, receive information from card issuers 1700 (similar to card issuer 20 of FIG. 1) and participating merchants 1800 (similar to merchants 30 of FIG. 1).

FIG. 3 illustrates how the contributions of several persons are aggregated for distribution to several charitable or tax-exempt organizations. Member 1 allocates his/her total contribution of $41.33 as follows—twenty-five percent of his/her contribution to organization A, fifty percent to organization B, fifteen percent to organization C and ten percent to organization E. Member 2 (with a total of $20.34), member 3 (with a total of $64.50), member 4 (with a total of $5.67) and member 5 (with a total of $34.21) make similar but different allocations so that the individual allocations to each organization are aggregated and distributed to the five organizations. This table is, of course, simplified. It is envisioned that many members and many organizations would be involved, but that the same or similar principles would be employed. As described above, the allocation may also include “not to exceed” amounts or fixed amounts subject to funding.

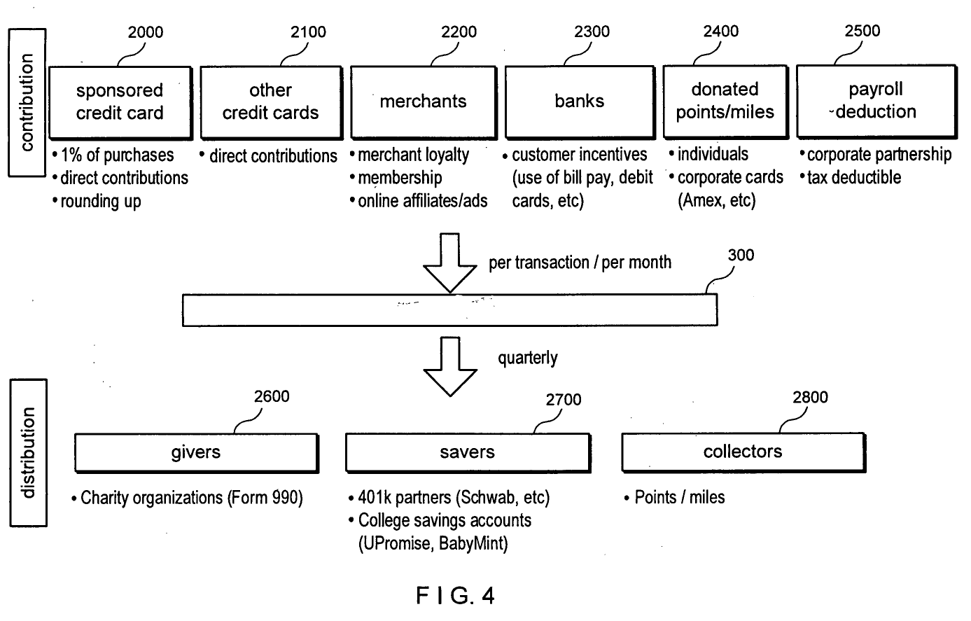

FIG. 4 illustrates a further expanded embodiment wherein funding or monetary flow is expanded to include more sources. The sponsored credit card 2000, other credit cards 2100, and merchant affinity programs 2200 have been described in the previous embodiments. However, the sponsored credit card 2000 can provide additional funding through direct contributions (that is, billing the cardholder for an additional amount, on a periodic or other basis) or “rounding up’ (that is, for example, charging the consumer's credit card $28.00 for a $27.40 purchase and allocating the extra sixty cents to funding of the present embodiment).

Additionally, banks 2300 can provide funding based on incentives to the consumer, such as, but not limited to the financial incentives that are provided by the use of electronic bill payment or the use of debit cards. Similarly, additional funding can be provided by the donation of airline points or corporate credit cards as illustrated in block 2400. Furthermore, funding can be provided by direct payroll deduction as shown in block 2500. The funds from the various sources are transferred periodically, typically monthly, to the aggregate account associated with contributions database 300 and are then distributed. FIG. 4 further illustrates that the distribution to various charities or tax exempt organizations 2600 can be supplemented with distributions to financial instruments 2700 (such as, but not limited to, 401(k) retirement accounts, Roth accounts, 529 college savings plans, or direct cash payments) for personal use or converted into points for specific merchants, airlines or similar entities 2800, likewise for personal use.

The method and apparatus results in many benefits for the cardholder, including no direct out-of-pocket giving requirements, flexibility in designating recipients and control via a secure web interface to manage and track donations. Similarly, the method and apparatus results in many benefits for charitable organizations, including access to a source of income previously available generally to the largest few organizations, little or no impact on administrative overhead, an exclusivity period as incentive for signing up new cardholders, and the opening of new channels for future giving options (as shown in FIG. 4). Finally, the method and apparatus results in many benefits for participating merchants, including providing a new channel to deliver value to an underserved market, goodwill from delivering more funds to charities and similar institutions, reduced card turnover and abandonment though flexible affinity, and lower marketing costs.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A method of accumulating and allocating funds, comprising the steps of:
registering members;
generating a monetary flow based, at least in part, on a portion of expenditures made by the members;
recording desired allocations from the members for said monetary flow among a plurality of charitable or tax-exempt organizations;
allocating the monetary flow of each member among the plurality of charitable or tax-exempt organizations according to said desired allocations thereby generating a monetary amount for at least some of said plurality of charitable or tax-exempt organization;
for at least some of said charitable or tax-exempt organizations, aggregating said monetary amounts from said members allocated to the respective charitable or tax-exempt organization thereby generating a donation amount; and
for at least some of said charitable or tax-exempt organizations, transmitting said donation amount thereto.

2. The method of claim 1 wherein said step of generating a monetary flow includes rebates from purchases made via a credit card by said members.

3. The method of claim 2 wherein said step of generating a monetary flow further includes rebates from at least some merchants from whom said members make purchases.

4. The method of claim 2 wherein said step of generating a monetary flow includes an option of direct contributions from said members, separate from the credit card.

5. The method of claim 2 wherein said step of generating a monetary flow includes an option of contributions from said members, made via the credit card.

6. The method of claim 1 wherein said step of recording desired allocations includes recording said desired allocations as percentages or fractions.

7. The method of claim 6 wherein said step of recording desired allocations further includes an option of the designation of a fixed amount of allocation or a limit to the allocation.

8. The method of claim 1 wherein said step of recording desired allocations can be subsequently repeated to alter the desired allocations.

9. The method of claim 1 wherein a portion of said desired allocations can further include allocations to financial instruments.

10. The method of claim 1 wherein said step of transmitting includes electronic funds transfer.

11. The method of claim 1 wherein said step of allocating is performed electronically.

12. The method of claim 1 wherein said step of aggregating is performed electronically.

13. A method of accumulating and allocating funds, comprising the steps of:
registering members on a first database;
generating a monetary flow based, at least in part, on a portion of expenditures made by the members, and recording the monetary flow on a second database;
recording desired allocations on a third database from the members for said monetary flow among a plurality of charitable or tax-exempt organizations;
allocating the monetary flow of each member among the plurality of charitable or tax-exempt organizations according to said desired allocations thereby generating a monetary amount for at least some of said plurality of charitable or tax-exempt organization;
for at least some of said charitable or tax-exempt organizations, aggregating said monetary amounts from said members allocated to the respective charitable or tax-exempt organization thereby generating a donation amount; and
for at least some of said charitable or tax-exempt organizations, transmitting said donation amount thereto.

14. The method of claim 13 wherein said step of generating a monetary flow includes rebates from purchases made via a credit card by said members.

15. The method of claim 14 wherein said step of generating a monetary flow further includes rebates from at least some merchants from whom said members make purchases.

16. The method of claim 14 wherein said step of generating a monetary flow includes an option of direct contributions from said members, separate from the credit card.

17. The method of claim 14 wherein said step of generating a monetary flow includes an option of contributions from said members, made via the credit card.

18. The method of claim 13 wherein said step of recording desired allocations includes recording said desired allocations as percentages or fractions.

19. The method of claim 18 wherein said step of recording desired allocations further includes an option of the designation of a fixed amount of allocation or a limit to the allocation.

20. The method of claim 13 wherein said step of recording desired allocations can be subsequently repeated to alter the desired allocations.

21. The method of claim 13 wherein a portion of said desired allocations can further include allocations to financial instruments.

22. The method of claim 13 wherein said step of transmitting includes electronic funds transfer.

23. The method of claim 13 wherein said step of allocating is performed electronically.

24. The method of claim 13 wherein said step of aggregating is performed electronically.

25. A method of accumulating and allocating funds, comprising the steps of:
registering members via a computer on a first database;
generating a monetary flow based, at least in part, on a portion of expenditures made by the members, and recording the monetary flow on a second database via electronic funds transfer;
recording desired allocations on a third database from the members via a computer for said monetary flow among a plurality of charitable or tax-exempt organizations;
allocating the monetary flow of each member among the plurality of charitable or tax-exempt organizations according to said desired allocations thereby generating a monetary amount for at least some of said plurality of charitable or tax-exempt organization;
for at least some of said charitable or tax-exempt organizations, aggregating said monetary amounts from said members allocated to the respective charitable or tax-exempt organization thereby generating a donation amount; and
for at least some of said charitable or tax-exempt organizations, transmitting said donation amount thereto via electronic funds transfer.

26. The method of claim 25 wherein said step of generating a monetary flow includes rebates from purchases made via a credit card by said members.

27. The method of claim 26 wherein said step of generating a monetary flow further includes rebates from at least some merchants from whom said members make purchases.

28. The method of claim 26 wherein said step of generating a monetary flow includes an option of direct contributions from said members, separate from the credit card.

29. The method of claim 26 wherein said step of generating a monetary flow includes an option of contributions from said members, made via the credit card.

30. The method of claim 25 wherein said step of recording desired allocations includes recording said desired allocations as percentages or fractions.

31. The method of claim 30 wherein said step of recording desired allocations further includes an option of the designation of a fixed amount of allocation or a limit to the allocation.

32. The method of claim 25 wherein said step of recording desired allocations can be subsequently repeated to alter the desired allocations.

33. The method of claim 25 wherein a portion of said desired allocations can further include allocations to financial instruments.

34. The method of claim 25 wherein said step of allocating is performed electronically.

35. The method of claim 25 wherein said step of aggregating is performed electronically.
